(19) United States
(12) Patent Application Publication
(10) Pub. No.: US 2025/0281903 A1
(43) Pub. Date: Sep. 11, 2025

(54) CHROMATOGRAPHIC COMPOSITION AND METHOD OF PRODUCING THE CHROMATOGRAPHIC COMPOSITION

(71) Applicant: Advanced Materials Technology, Inc., Wilmington, DE (US)

(72) Inventor: Barry Edward Boyes, Wilmington, DE (US)

(21) Appl. No.: 18/862,255

(22) PCT Filed: May 12, 2023
(86) PCT No.: PCT/US2023/022009

§ 371 Date: Nov. 1, 2024

Related U.S. Application Data
(60) Provisional application No. 63/341,617, filed on May 13, 2022.

(51) Int. Cl. B01J 20/32; B01D 15/30; B01J 20/288; B01J 20/289

(52) U.S. Cl. CPC B01J 20/3219; B01D 15/305; B01J 20/288; B01J 20/289; B01J 20/3204; B01J 20/3227

(57) ABSTRACT

A chromatographic composition includes a solid phase substrate and an ionically-modified hydrophilic ligand coupled to the solid phase substrate. The ionically-modified hydrophilic ligand includes a hydrophilic ligand portion covalently bonded to the solid phase substrate with the hydrophilic ligand including a polar group and a plurality of hydroxyl groups. The ionically-modified hydrophilic ligand also includes an ionic group directly or indirectly coupled to the hydrophilic ligand portion. Methods of producing the chromatographic composition are also provided.

### CROSS-REFERENCE TO RELATED APPLICATIONS

This application claims priority to and all the advantages of U.S. Provisional Patent Application No. 63/341,617, filed May 13, 2022, the entire contents of which are hereby incorporated by reference.

### FIELD OF THE DISCLOSURE

The present disclosure generally relates to a chromatographic composition for use in chromatographic separations.

### BACKGROUND

High Performance Liquid Chromatography (HPLC) is a process of separating components in a liquid mixture. Various forms of HPLC exist, such as ion exchange, reversed-phase, and hydrophilic interaction liquid chromatography (HILIC), and mixed-mode hydrophilic interaction liquid chromatography, with ion exchange characteristics. Each of these variants include a mobile phase and a stationary phase that cooperate to accomplish the separation. Despite the general ability of liquid chromatography to retain and separate polar analytes, conventional stationary phases are not optimized to separate certain mixtures of low molecular weight, highly polar substances, such as perfluoroalkyl substances (PFAS). Thus, there remains an opportunity to develop an improved chromatographic composition.

### SUMMARY OF THE DISCLOSURE AND ADVANTAGES

In one aspect of the present disclosure, a chromatographic composition is provided. The chromatographic composition includes a solid phase substrate and an ionically-modified hydrophilic ligand coupled to the solid phase substrate. The ionically-modified hydrophilic ligand includes a hydrophilic ligand portion covalently bonded to the solid phase substrate with the hydrophilic ligand including a polar group and a plurality of hydroxyl groups. The ionically-modified hydrophilic ligand also includes an ionic group directly or indirectly coupled to the hydrophilic ligand portion.

In another aspect of the present disclosure, a method of producing the chromatographic composition is provided. The method includes providing a solid phase substrate and providing a hydrophilic ligand including a polar group and a plurality of hydroxyl groups with at least one hydroxyl group present at a terminus of the hydrophilic ligand. The method also includes reacting the solid phase substrate and the hydrophilic ligand to covalently couple the hydrophilic ligand to the solid phase substrate to form a hydrophilic-modified substrate. The method further includes providing an activation compound including a leaving group, and reacting the activation compound with the terminus hydroxyl group of the hydrophilic-modified substrate to form an activated hydrophilic-modified substrate. The method further includes providing an ionic modifier including a nucleophile and an ionic group, and reacting the activated hydrophilic-modified substrate with the ionic modifier to release the leaving group of the activation compound and form the ionically-modified hydrophilic ligand and the chromatographic composition.

In another aspect of the present disclosure, a second method of producing the chromatographic composition is provided. The method includes providing a solid phase substrate and providing a hydrophilic ligand including a polar group and a plurality of hydroxyl groups with at least one hydroxyl group present at a terminus of the hydrophilic ligand. The method also includes reacting the solid phase substrate and the hydrophilic ligand to covalently couple the hydrophilic ligand to the solid phase substrate to form a hydrophilic-modified substrate. The method further includes providing an activation compound including a leaving group and providing an providing an ionic modifier including a nucleophile and an ionic group. The method further includes reacting the activation compound and the ionic modifier to from an activated ionogenic compound. The method further includes reacting the terminus hydroxyl group of the hydrophilic-modified substrate and the activated ionogenic compound to form the ionically-modified hydrophilic ligand.

The chromatographic composition is useful for chemical separations. For example, the chromatographic composition is useful as a stationary phase in HPLC separations, such as, ion exchange chromatography, HILIC, and mixed-mode HILIC. Without being held to any particular theory, it is believed that the ionically-modified hydrophilic ligand provides superior separation ability in HPLC separations for select analytes, such as PFAS, when compared to chromatographic compositions that include hydrophilic ligands without ionic modification.

### BRIEF DESCRIPTION OF THE DRAWINGS

Advantages of the present invention will be readily appreciated, as the same becomes better understood by reference to the following detailed description, when considered in connection with the accompanying drawings.

FIG. 1 is a chromatogram showing the separation of low molecular weight PFAS compounds with a conventional chromatographic composition including a hydrophilic ligand coupled to the surface of silica.

FIG. 2 is a chromatogram showing the separation of low molecular weight PFAS compounds with a chromatographic composition including an ionically-modified hydrophilic ligand coupled to the surface of silica at a density of 0.6 μmol/m².

FIG. 3 is a chromatogram showing the separation of low molecular weight PFAS compounds with the chromatographic composition including the ionically-modified hydrophilic ligand coupled to the surface of silica at a density of 1.2 μmol/m².

FIG. 4 is a chromatogram showing the separation of low molecular weight PFAS compounds with the chromatographic composition including the ionically-modified hydrophilic ligand coupled to the surface of silica at a density of 1.7 μmol/m².

### DETAILED DESCRIPTION OF THE DISCLOSURE

The present disclosure provides a chromatographic composition. The chromatographic composition is useful in chemical separations, particularly HPLC separations that include a stationary phase and a mobile phase. In certain aspects, the chromatographic composition is particularly useful as the stationary phase for ion exchange chromatography, HILIC, and mixed-mode HILIC.

The chromatographic composition includes a solid phase substrate and an ionically-modified hydrophilic ligand coupled to the solid phase substrate. In certain aspects, coupled to the solid phase substrate means covalently bonded to the solid phase substrate. The ionically-modified hydrophilic ligand includes a hydrophilic ligand portion covalently bonded to the solid phase substrate, and an ionic group directly or indirectly coupled to the hydrophilic ligand portion. The hydrophilic ligand portion includes a polar group and a plurality of hydroxyl groups.

The polar group of the hydrophilic ligand portion may be selected from a carbonate, a carbamate, an amide, an amine, a ureido, an ether, a thioether, a sulfinyl, a sulfoxide, a sulfonyl, a thiourea, a thiocarbonate, or a thiocarbamate, including heterocyclic compounds including the polar functionality. For example, the polar group may be an aromatic ring including an amine. In one aspect, the polar group X is selected from an amide or a carbamate. The plurality of hydroxyl groups present on the hydrophilic ligand portion may be 2 or more hydroxyl groups. Alternatively, the hydrophilic ligand portion may include 2 to 8, 2 to 7, or 3 to 5, hydroxyl groups.

Referring first to the solid phase substrate, although not required, the solid phase substrate is typically silica. The silica used for the chromatographic composition is not limited to any particular grade. Both nonporous spherical silica and porous silica, including superficially porous silica, may be used. The silica particles typically have an average diameter particle size of from 0.5-100 μm, 1-50 μm, 1.5-10 μm, or from 1.7-5 μm. The porous silica may have an average pore diameter of greater than or equal to about 80 Å, greater than or equal to about 250 Å, greater than or equal to about 300 Å, greater than or equal to about 450 Å, from 200 to 1,000 Å, from 250 to 900 Å, or from 300 to 850 Å. Alternatively, although pore diameters below 70 Å are typically avoided, it is contemplated that the average pore diameter may be from about 1 to about 50 Å, from about 5 to about 40 Å, or from about 10 to about 30 Å. The surface of the silica particles typically include silica hydroxyl groups, so-called silanols, useful for covalent coupling of various reagents to the silica surface. Mostly commonly, specific organosilane reagents are employed for these silica surface modifications, to form a covalently-attached bonded phase. Suitable grades of silica are available under the tradename Halo Silica from Advanced Materials Technologies having a principal place of business in Wilmington, DE, but many silica materials are widely available as commercial materials for a variety of useful applications. Alternative substrates include hybrid inorganic/organic material. Within the context of this disclosure, the term “hybrid inorganic/organic material” includes inorganic-based structures wherein an organic functionality is integral to both the internal (i.e., inorganic structure as well as the hybrid material surface). The inorganic portion of the hybrid material may be, e.g., alumina, silica, titanium, cerium, or zirconium or oxides thereof, or ceramic material. Further alternative substrates include completely organic substrates that include hydroxyl groups at the surface of the organic substrate. For the purposes of this disclosure, the solid phase substrate is not formed from carbohydrates. However, carbohydrates could be included when covalently bonded to inorganic or hybrid inorganic/organic materials.

Although not required, the ionically-modified hydrophilic ligand may be derived from Formula I:

(R¹O)₃Si—[C(R²)(R³)]ₙ—X—[C(R²)(R³)]_{n′}—[C(R⁴)(R⁵)]ₘ—Zₚ—Yₛ Formula I
wherein:
X is the polar group;
Z is a polar connecting group;
Y is the ionic group;
n is 1-6;
n′ is 0-2;
m is 2-8;
p is 0 or 1;
s is 1;
R¹, R², R³, is independently H or a straight or branched, substituted or unsubstituted, C1 to C18 alkyl group; and
R⁴ and R⁵ is independently H or OH and at least two m units include at least one hydroxyl group.

It is to be appreciated that because the ionically modified hydrophilic ligand is coupled to the solid phase substate, a reaction occurs between the surface hydroxyl groups present on the solid phase substrate and one of the three [(R¹O)] units present in Formula I. Thus, the ionically modified hydrophilic ligand is derived from Formula I and is represented by Formula I prior to its reaction with the solid phase substrate.

When the ionically-modified hydrophilic ligand is represented by Formula I, the hydrophilic ligand portion is derived from Formula Ia:

(R¹O)₃Si—[C(R²)(R³)]ₙ—X—[C(R²)(R³)]_{n′}—[C(R⁴)(R⁵)]ₘ— Formula Ia
X is the polar group;
n is 1-6; and
n′ is 0-2;
R¹, R², R³, is independently H or a straight or branched, substituted or unsubstituted, C1 to C18 alkyl group; and
R⁴ and R⁵ is independently H or OH and at least two m units include at least one hydroxyl group.

Although not required, typically p is 1 such that the polar connecting group is present in the ionically-modified hydrophilic ligand.

The polar group X is independently chosen from a carbonate, a carbamate, an amide, an amine, a ureido, an ether, a thioether, a sulfinyl, a sulfoxide, a sulfonyl, a thiourea, a thiocarbonate, or a thiocarbamate, including heterocyclic compounds including the polar functionality. For example, the polar group may be an aromatic ring including an amine. In one aspect, the polar group X is selected from an amide or a carbamate. In another aspect, the polar group X is an amide. When the polar group X is an amide, the ionically-modified hydrophilic ligand may be derived from Formula Ib:

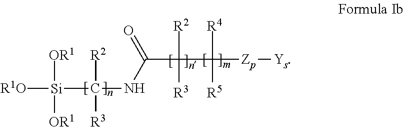

In certain aspects of Formula I and Formula Ib, n is 2-4, m is 3-6, p is 1, and R¹, R², R³ is independently H or a straight or branched, substituted or unsubstituted, C1 to C6 alkyl group. Although not required n′ is typically 0 when X is an amide. In other aspects of Formula I, when X is a ureido, n′ is 1 or 2. In one aspect of Formula Ib, n is 3, X is an amide, m is 5, and four of the m units include only one hydroxyl group. In one aspect, the ionically-modified hydrophilic ligand is derived from Formula Ic:

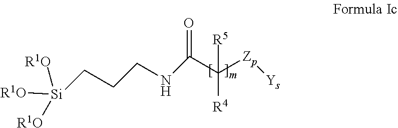

In certain aspects, p is 1 such that the polar connecting group Z is included in the ionically-modified hydrophilic ligand. Although not required, the polar connecting group Z is typically a carbamate group when p is 1. In certain aspects of Formula Ic, in which the polar group X is an amide, the polar connecting group Z is also present, m is 5 with four of the m units including only one hydroxyl group, and the ionically-modified hydrophilic ligand is derived from Formula II:

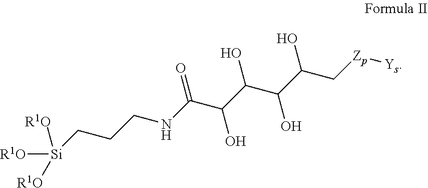

When polar linking group Z is a carbamate group, Formula II is further represented by Formula IIa:

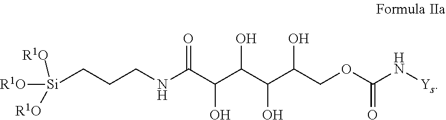

Referring now to the ionic group Y, typically the ionic group Y is derived from an ionic modifier including a nucleophile and an ionic group (described further below). The ionic group Y may also be represented by Formula III:

[C(R⁶)(R⁷)]ₖ—I Formula III
k is 1-8;
R⁶ and R⁷ is independently H or a straight or branched, substituted or unsubstituted, C1 to C18 alkyl group, which may also contain halocarbon or alcohol substitutions; and
I is a charge-bearing functional group capable of either (1) bearing a positive ionic charge in neutral or acidic aqueous or aqueous organic solvent conditions, or (2) bearing a negative ionic charge in suitably neutral or basic aqueous or aqueous organic solvent conditions.

Persons of ordinary skill in the art will understand that the phrase “capable of” within the context of bearing an ionic charge means that the ionic group is either positive or negative when exposed to the aqueous or aqueous organic solvent conditions described above. Persons of ordinary skill in the art will also understand that when the ionic group is not exposed to the fluid conditions, the ionic group is not required to be cationic or anionic.

In certain aspects, the ionic group I capable of bearing a positive charge and is a primary, secondary, tertiary, quaternary amine or aromatic amine. When the ionic group I is a primary, secondary, tertiary, quaternary or aromatic amine, the nitrogen atom of the amine may be bonded to hydrogen, an alkyl, an alcohol substituted alkyl, an aromatic group, and combinations thereof. In other words, the ionic group I may be bonded at more than one position to hydrogen, an alkyl, an alcohol substituted alkyl, and an aromatic group, including as part of a heterocyclic compound. In one aspect, the ionic group is a tertiary amine and is bonded to two ethyl groups. In other aspect, the ionic group I is part of a heterocyclic compound, I may be:

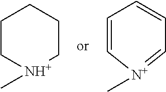

In alternative aspects, the ionic group capable of bearing a negative charge is an immobilized carboxylic acid or sulfonic acid.

Referring still to Formula III, typically k is 2-6, and R⁶ and R⁷ are hydrogen.

In certain aspects of the ionically-modified hydrophilic ligand, the polar group X is an amide, Z is present and is a carbamate group, m is 3-7, n is 2 to 4, n′ is 0 or 1, at least four m units include only one hydroxyl group, and the ionic group Y includes a tertiary amine. In another aspect, the ionically-modified hydrophilic ligand is derived from Formula IV:

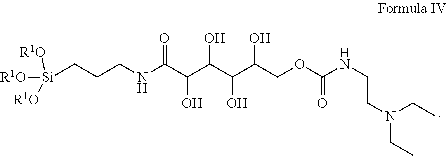

Referring back to the chromatographic composition as a whole, in addition to having the ionically-modified hydrophilic ligand coupled to the solid phase substrate, the chromatographic composition may also have a hydrophilic ligand coupled to and/or covalently bonded to the solid phase substrate. In other words, when the hydrophilic ligand is present along with the ionically-modified hydrophilic ligand, the hydrophilic ligand is not ionically modified.

The polar group of the hydrophilic ligand may be selected from a carbonate, a carbamate, an amide, an amine, a ureido, an ether, a thioether, a sulfinyl, a sulfoxide, a sulfonyl, a thiourea, a thiocarbonate, or a thiocarbamate, including heterocyclic compounds including the polar functionality. For example, the polar group may be an aromatic ring including an amine. In one aspect, the polar group is selected from an amide, or a carbamate. The plurality of hydroxyl groups present on the hydrophilic ligand may be 2 or more hydroxyl groups. Alternatively, the hydrophilic ligand may include 2 to 8, 2 to 7, or 3 to 5, hydroxyl groups.

In one aspect, the hydrophilic ligand is derived from Formula V:

(R¹O)₃Si—[C(R²)(R³)]ₙ—X—[C(R²)(R³)]_{n′}—[C(R⁴)(R⁵)]ₘ—[C(R⁸)(R⁹)]_{q} Formula V
X is the polar group;
n is 1-6;
n′ is 0-2;
m is 2-8;
q is 1;
R¹, R², R³, is independently H or a straight or branched, substituted or unsubstituted, C1 to C18 alkyl group;
R⁴ and R⁵ is independently H or OH and at least two m units include at least one hydroxyl group; and
R⁸ and R⁹ is independently H or OH provided that at least one of R⁸ and R⁹ is OH. The hydroxyl group of R⁸ and/or R⁹ included in unit q may also be referred to as a terminal hydroxyl group. Those having ordinary skill in the art will appreciate that the ionically-modified hydrophilic ligand portion of ionically-modified hydrophilic ligand and the hydrophilic ligand share a similar structure, with the exception that the hydrophilic ligand portion does not include unit q (i.e., —[C(R⁸)(R⁹)]_{q}) and thus does not include a terminal hydroxyl group. Accordingly, the hydrophilic ligand may include each of the various structural configurations of the hydrophilic ligand portion described above with the exception that the hydrophilic ligand further includes the q unit.

In one aspect, the hydrophilic ligand of Formula V is further derived from Formula Va:

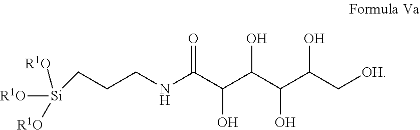

When the chromatographic composition includes the hydrophilic ligand in addition to the ionically-modified hydrophilic ligand, the relative amount of each ligand can be optimized based on the particular analyte that is the subject of the separation. For example, in certain aspects, the ionically-modified hydrophilic ligand and the hydrophilic ligand are present in a molar ratio range of from of 1:10 to 10:1. Alternatively, the ionically-modified hydrophilic ligand and the hydrophilic ligand may be present in a molar ratio range of from 2:8 to 8:2, from 3:7 to 7:3, from 4:6 to 6:4, or about 1:1. In certain aspects, the solid phase substrate is a superficially porous silica that is covalently boned to the ionically-modified hydrophilic ligand represented by Formula I and the hydrophilic ligand represented by Formula V. Alternatively, in one aspect, the solid phase substrate is a superficially porous silica that is covalently boned to the ionically-modified hydrophilic ligand represented by Formula Va and the hydrophilic ligand represented by Formula II.

The present disclosure also provides a method of producing the chromatographic composition. The method includes providing the solid phase substrate and providing the hydrophilic ligand including the polar group and the plurality of hydroxyl groups. At least one hydroxyl group is present at a terminus of the hydrophilic ligand, and typically only one hydroxyl group is present at the terminus. Both the solid phase substrate and the hydrophilic ligand are described above. The method further includes reacting the solid phase substrate and the hydrophilic ligand to covalently couple the hydrophilic ligand to the solid phase substrate to form a hydrophilic-modified substrate. The method further includes providing an activation compound including a leaving group and reacting the activation compound preferentially with the terminus hydroxyl group of the hydrophilic-modified substrate to form an activated hydrophilic-modified substrate. The terminal hydroxyl group is by design a primary hydroxyl group, whereas in other examples, the hydrophilic ligand possesses secondary hydroxyl groups. This differentiation can permit selective reaction of the primary hydroxyl group relative to secondary hydroxyl groups. In other words, the method includes a first reaction between the solid phase substrate and a second reaction between the reaction product of the first reaction (i.e., the hydrophilic-modified substrate) and the activation compound. The method further includes providing an ionic modifier including a nucleophile and an ionic group and reacting the ionic modifier with the activated-hydrophilic-modified substrate to release the leaving group of the activation agent and form the ionically-modified hydrophilic ligand covalently coupled to the solid phase substrate. In other words, the method also includes a third reaction between the reaction product of the second reaction (i.e., the reaction between the activation compound and the hydrophilic-modified substrate) and the ionic modifier. The resulting reaction product of the third reaction is the chromatographic composition including the ionically-modified hydrophilic ligand covalently coupled to the solid phase substrate.

Referring first to the first reaction between the solid phase substrate and the hydrophilic ligand, the reaction occurs between the surface hydroxyl groups present on the solid phase substrate and one of the three [(R¹O)] units present in Formula V:

(R¹O)₃Si—[C(R²)(R³)]ₙ—X—[C(R²)(R³)]_{n′}—[C(R⁴)(R⁵)]ₘ—[C(R⁸)(R⁹)]_{q} Formula V.

The resulting reaction product produces the hydrophilic-modified substrate and preserves the hydroxyl group in the q unit represented by [C(R⁸)(R⁹)].

Typically, the second reaction between the hydrophilic-modified substrate and the activation compound occurs under aprotic anhydrous solvent conditions, to limit hydrolytic loss of the activated conjugate. The activation compound may include a carbonyl group. Specific examples of the activating compound including the carbonyl group include, but are not limited to, phosgene (carbonyl dichloride), carbonyldiimidazole (CDI), or chloroformates, such as 4-nitrophenyl chloroformate (4-NPC), or carbonates, such as N,N′-disuccinimidyl carbonate (DSC), or a combination thereof. An illustrative example of the second reaction product between the hydrophilic ligand of Formula Va and DSC is provided below, to form the N-hydroxysuccinimdyl (NHS) carbonate of the 3-TPG compound.

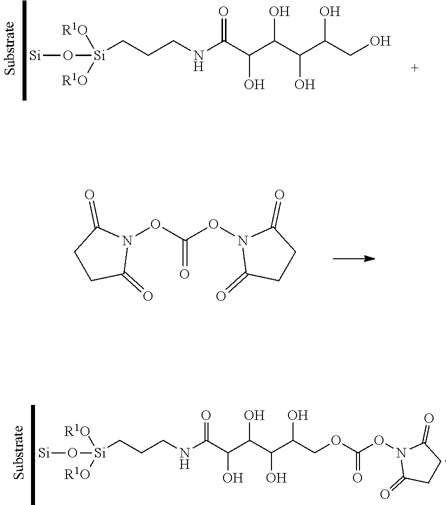

Alternative activation compounds include compounds having a tosylate group, such as, but not limited to, tosyl chloride (4-toluenesulfonyl chloride). Further suitable activation compounds include mesyl chloride (methanesulfonyl chloride), triphenylmethylene chloride (tritylchloride), phosphorus tribromide, or thionyl chloride. Although not typical, any of the reaction compounds can be used in combination with alternative activation compounds.

Without being bound to any particular theory, it is believed that under suitable conditions the activation compounds described herein can selectively react with the terminal hydroxyl group of the hydrophilic ligand. The selective reaction at the terminal hydroxyl group is also considered to be an important aspect of the present disclosure as uniformity, and the general avoidance of multiple reaction products, cross-linked intermediates or cyclic carbonates and the like, and is favorable to achieving consistent chromatographic separations. Once the hydrophilic ligand is reacted with the activation compound, the hydrophilic ligand portion of Formula Ia is established.

The ionic modifier may be represented as Formula VI,

W—[C(R⁶)(R⁷)]ₖ—I Formula VI,
W is a nucleophile;
k is 1-8;
R⁶ and R⁷ is independently H or a straight or branched, substituted or unsubstituted, C1 to C18 alkyl group, which may also contain halocarbon or alcohol substitutions;
I is a charge-bearing functional group capable of either i. bearing a positive ionic charge in neutral or acidic aqueous or aqueous organic solvent conditions, or ii. bearing a negative ionic charge in suitably neutral or basic aqueous or aqueous organic solvent conditions.

In certain aspects, the ionic modifier is selected from N,N-(diethyl)-diaminoethane, 4-(aminoethyl)pyridine, 2-aminoethanesulfonic acid, 2-aminoethanesulfinic acid, and 3-aminopropanesulfonic acid. In another aspect, the ionic group of the ionic modifier is a tertiary amine. In another aspect, the ionic modifier is N,N-(diethyl)-diaminoethane.

An illustrative example of the third reaction product obtained from reacting N,N-(diethyl)-diaminoethane with the reaction product illustrated above is provided.

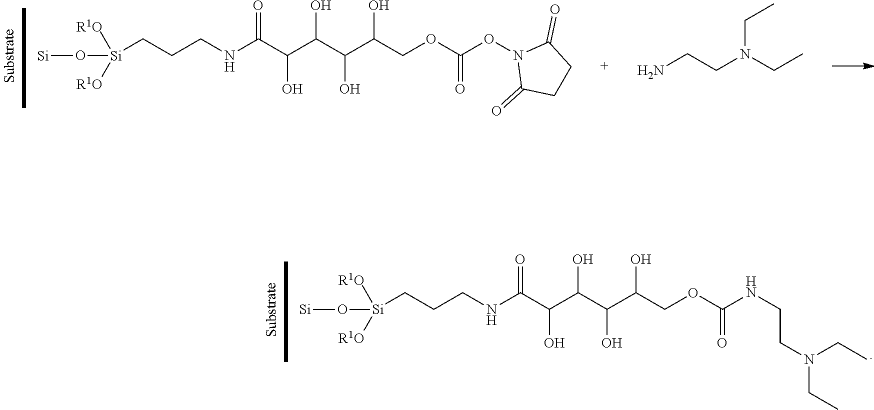

As shown above, the reaction between the second reaction product and N,N-(diethyl)-diaminoethane displaces the leaving group of the activation compound and creates a carbamate (urethane) linkage. The carbamate (urethane) linkage is representative of the polar connecting group Z in Formula I. And the ionic group of the ionic modifier is the ionic group Y of Formula I.

The present disclosure provides another method (i.e., second method) of producing the chromatographic composition. Similar to the first method, the second method includes providing the solid phase substrate and providing the hydrophilic ligand including the polar group and the plurality of hydroxyl groups. At least one hydroxyl group is present at a terminus of the hydrophilic ligand, and typically only one hydroxyl group is present at the terminus. Both the solid phase substrate and the hydrophilic ligand are described above. The method further includes reacting the solid phase substrate and the hydrophilic ligand to covalently couple the hydrophilic ligand to the solid phase substrate to form a hydrophilic-modified substrate. Unlike the first method, the second method provides the activation compound including a leaving group and further includes providing the ionic modifier including a nucleophile and an ionic group and reacting the ionic modifier and the activation compound to form an activated ionogenic compound. In other words, unlike the first method, the second method reacts the activation compound and the ionic modifier prior to either of these components being coupled to the solid phase substrate or hydrophilic-modified substrate. Instead, the ionic modifier and activation compound are reacted “off-particle” and the resulting reaction product, the activated ionogenic compound, is then reacted with the hydrophilic-modified substrate via the terminal hydroxyl of the hydrophilic ligand portion to form the chromatographic composition. As described above, the terminal hydroxyl group is by design a primary hydroxyl group. As described above, there are many options for activation of the ionogenic compound to couple the ionogenic compound to the hydrophilic-modified substrate. For example, suitable activation compounds include compounds having a tosylate group, such as, but not limited to, tosyl chloride (4-toluenesulfonyl chloride). Further suitable activation compounds include mesyl chloride (methanesulfonyl chloride), triphenylmethylene chloride (tritylchloride), phosphorus tribromide, or thionyl chloride. Although not typical, any of the reaction compounds can be used in combination with alternative activation compounds. These compounds will generally be chosen to couple the ionogenic compound to the terminus hydroxyl group, which could be considered a weakly nucleophilic reactive site. A reaction scheme illustrating the an exemplary reaction product between the activation compound and ionic modifier to produce the ionogenic compound is shown below.

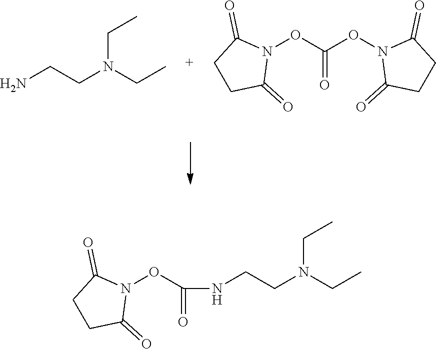

The subsequent reaction product between the ionogenic compound and the hydrophilic ligand coupled to the solid phase substate is shown below.

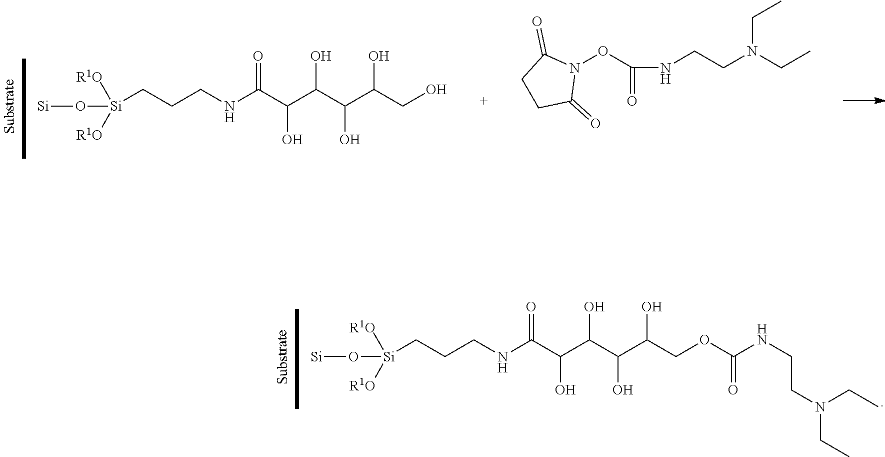

As described above, the chromatographic composition is useful for HPLC separations, including HILIC, mixed-mode HILIC, and ion exchange chromatography. Further uses include, but are not limited to, a thin layer plate, a filtration membrane, a microfluidic separation device, a sample cleanup device, a solid support, a solid phase extraction device, a microchip separation device, or a microtiter plate. The chromatographic composition may also be included in a kit, with the kit optionally including instructions for use of the chromatographic composition.

The method of producing the chromatographic composition may also include coupling both the ionically-modified hydrophilic ligand and the hydrophilic ligand (i.e., non-ionically modified) to the solid phase substrate by controlling the stoichiometry of the second reaction. Specifically, after the hydrophilic ligand has been covalently coupled to the surface of the solid phase substrate, the hydrophilic ligand in its current state may be preserved by including fewer moles of the activation compound than the number of moles of the hydrophilic ligand coupled to the substrate. Notably, because the ionizing agent will only react with the activated hydrophilic ligand and will not react with the hydrophilic ligand (i.e., non-activated hydrophilic ligand) the remaining hydrophilic ligand is preserved in an unmodified state. As an alternative, the reactions of activation and modification of the hydrophilic ligand can occur in free solution, yielding a mixture, which can thereafter be covalently bonded to a solid phase carrier.

### EXAMPLES

Those skilled in the art will recognize that equivalents of the following instruments and suppliers exist and, as such, the instruments listed below are not to be construed as limiting.

The elemental analysis (% C, % H, % N) values were measured by combustion analysis (Robertson Microlit Laboratories, Ledgewood, NJ). These values were employed to establish ligand coverage measures based on known composition of compounds and Specific Surface Areas (m2/g). The specific surface areas (SSA), specific pore volumes (SPY) and the average pore diameters (APD) of these materials were measured using the multi-point N₂ sorption method (Micromeritics ASAP 2400; Micromeritics Instruments Inc., Norcross, Ga.). The SSA was calculated using the BET method, the SPY was the single point value determined for P/Pₒ>0.98 and the APD was calculated from the desorption portion of the isotherm using the BJH method. Particle sizes were measured using a Beckman Coulter Multisizer 3 analyzer (30 μm aperture, 70,000 counts; Miami, Fla.). The particle diameter (dp) was measured as the 50% cumulative diameter of the volume-based particle size distribution. The width of the distribution was measured as the 90% cumulative volume diameter divided by the 10% cumulative volume diameter (denoted 90/10 ratio). Generally, values of surface coverage are expressed as normalized to the elemental composition and SSA of samples, to yield molar surface coverage of the silica surface with ligand in μmol/m².

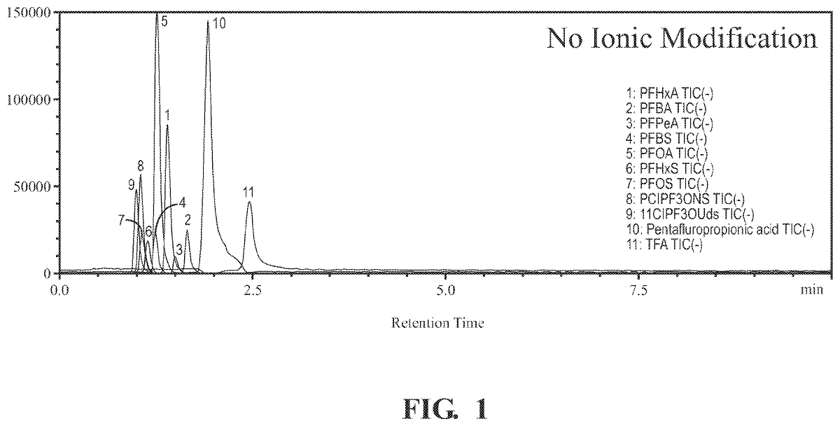

Commercially available 2.7 μm diameter fully hydroxylated superficially porous silica particles (25 g of Halo Silica, Advanced Materials Technologies, Wilmington, DE, SSA=120 m²/g; APD=90 Å) were dispersed while under a blanket of nitrogen, refluxed in toluene (250 mL, Millipore/Sigma, St. Louis, NJ) using a Dean-Stark trap for 1 hour, to collect a small quantity of adsorbed water. After brief cooling to about 65° C., a quantity of 12 mmol of diisopropylethylamine (DIPEA, Sigma-Aldrich, St. Louis, MO) was added with stirring, followed by 36 mmol of N-(3-triethoxysilylpropyl) gluconamide, (3TPG, 30% in ethanol, Gelest Inc., Morrisville, PA). The resulting mixture was heated to 78° C., to remove the bulk of ethanol, then brought to reflux overnight, with occasional collection of about 5 mL portions of solvent to aid removal of the ethanol evolved during bonding of the ethoxy-silane to the surface of the silica particles. After cooling, the resulting silica particles were collected by filtration on a sintered glass funnel, washed with 200 mL of warm toluene, THF, acetonitrile, then methanol (all solvents from Sigma-Millipore), dried on filter, then the silica was further dried in a vacuum oven at 110° C. for at least 1 hour. The resulting 3-TPG bonded silica then underwent an additional bonding reaction in 250 mL of dimethylformamide (DMF, Sigma-Aldrich, St. Louis, MO), using 6 mmol of DIPEA, and 18 mmol of 3-TPG, at a temperature of 85° C. overnight, with occasional removal of about 5 mL of solvent through the Dean-Stark trap. After cooling, the solids are recovered by filtration, washing with warm DMF, then acetonitrile, followed by dispersion into 50% acetonitrile/water, then collection by filtration and washing with acetonitrile and methanol. The silica was dried as before under vacuum at 110° C. The resulting 3-TPG bonded silica particles are densely bonded with 3-TPG, with elemental analysis typically revealing 3.5-3.8 μmol/m² of silica surface. Chromatographic analysis of the resulting materials reveals typical retention properties for hydrophilic interaction liquid chromatography, one example of which is as shown in FIG. 1.

### Ionic Modification

3-TPG bonded silica particles of Example 1 are dried in a vacuum oven for 2 hours. A suitable portion of 5-20 g of the material is dispersed in volume of 10 mL per g, using dry acetonitrile (Sigma-Aldrich, St. Louis, MO), then a quantity of 0.2 mmol/g of 4-dimethylaminopyridine (DMAP, Sigma-Aldrich) is added, with stirring at room temperature, followed by a quantity of disuccinimidylcarbonate (DSC, Oakland Chemicals), which was 0.24 mmol/g (Rx 3a), 0.48 mmol/g (Rx3b), or 0.96 mmol/g (Rx 3c), added with stirring and dispersion in an ultrasonic bath. The reaction to form NHS activated intermediates proceeds for 1.5 hours at room temperature under nitrogen, after which each of these reaction mixtures are maintained separate, and the silica particles are collected on filter, washed with volumes of 25 mL/g of dry acetonitrile, THF, 20% THF in 1 mM HCl in water, then THE, acetonitrile and methanol. After drying under vacuum at room temperature, the activated 3-TPG silicas are dispersed at 10 mL/g silica solid in acetonitrile, with stirring, to which is added 5 mmol/g of (2-aminoethyl) diethylamine, for overnight reaction under a blanket of nitrogen.

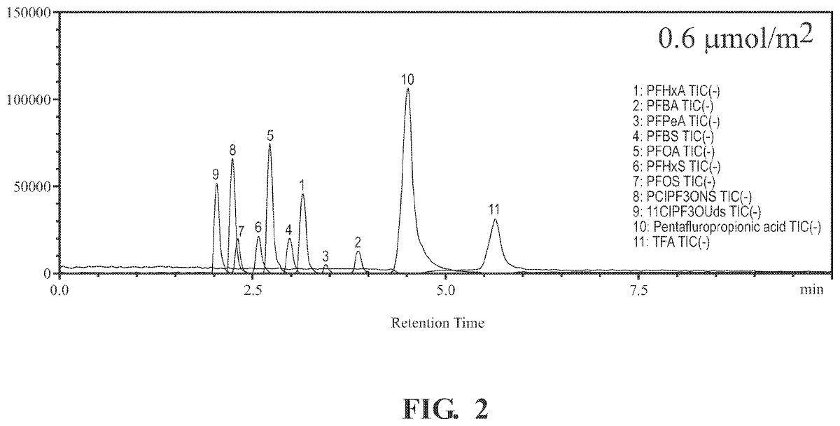

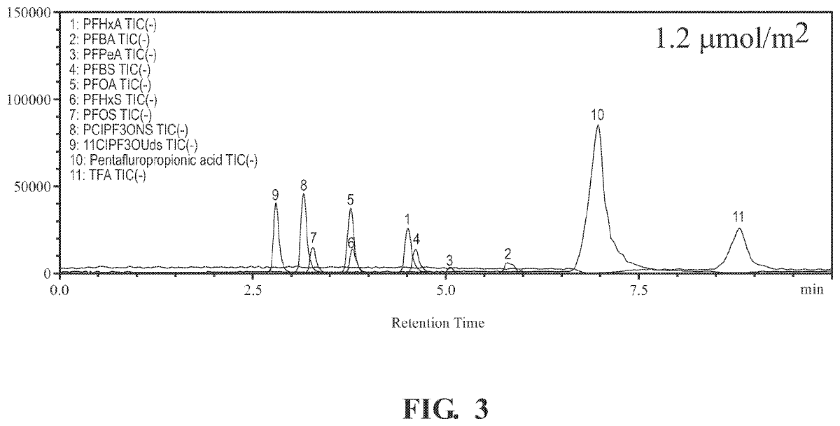

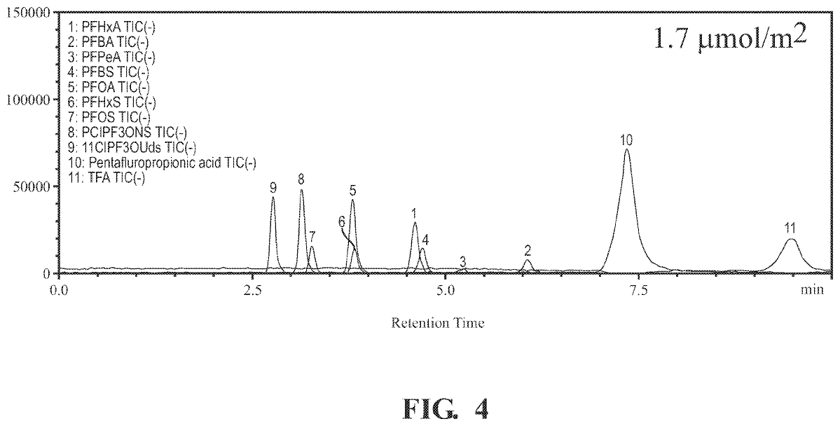

The resulting reaction products of DEAE addition were collected by centrifugation (1000×g, 5 minutes), dispersed in acetonitrile, then washed twice by dispersion and collection using centrifugation in 10 mL/g of acetonitrile. Hydrolysis of remaining unreacted NHS modified sites was conducted by dispersing the silica particles in a solution of 0.2 M carbonate buffer (pH 9.5)/10% acetonitrile, with mixing for 30 minutes, followed by dispersion in 0.5 M Tris Buffer (pH 7.8) for 30 minutes. The modified silicas were then washed twice by dispersion and centrifugation in water, then collected by dispersion in 10 ml/g of water, vacuum filtration, and washing on filter with about 10 mL/g of acetonitrile and methanol, before drying on filter followed by vacuum oven drying at 110° C. In this example, activation variation was conducted, with subsequent excess availability of (2-aminoethyl) diethylamine as the ionic modifying reagent. Elemental analysis of the resulting silica particles indicated that the variation of activating agent treatment (quantity) results in predictable and controlled addition of the ionic DEAE groups to the surface, with the result of adding 0.6 μmol/m², 1.2 μmol/m², and 1.7 μmol/m² of DEAE functional groups with activation by DSC at 0.24 mmol/g, 0.48 mmol/g and 0.96 mmol/g of TPG silica, respectively. Chromatographic analysis of the resulting ionically modified material reveals typical retention properties for hydrophilic interaction liquid chromatography, examples of which are as shown in FIGS. 2-4 with varying degrees of surface modification.

### Chromatographic Separation of PFAS

3-TPG and ionically-modified 3-TPG silicas were employed to load stainless steel HPLC columns of 2.1 internal diameter×100 mm length. These columns were tested for separations of PFAS standards (Wellington Laboratories, Guelph, ON, Canada), by injection of 1 μL of suitably diluted standard mixture. Separation was accomplished using the Shimadzu Nexera LC instrument, at a flow rate of 0.4 mL/min, at a column temperature of 40° C., using linear gradient elution program of 70% A/30% B to 20% A/80% B over the course of 10 minutes, in which A is composed of 60% acetonitrile/40% methanol with 0.1% formic acid, and B is composed of 10 mM ammonium formate/0.1% formic acid in water. Detection of the individual PFAS compounds occurred by online mass spectroscopy coupled to the HPLC separation, using the Shimadzu LCMS-8040 triple quadrupole instrument. The results shown in the attached Figures are negative ion electrospray (ESI) total ion currents for precursor fragments identified by the MS system, using precursor masses appropriate for each compound.

Notably, the three samples of chromatographic material with ionically-modified hydrophilic ligands exhibited increasing retention of the anionic analytes (ionized perfluorocarbons), paralleling the degree of surface cation modification, with significantly better separation performance (FIGS. 2-4) when compared to the conventional chromatographic material (FIG. 1).

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described. The subject matter of all combinations of independent and dependent claims, both singly and multiply dependent, is herein expressly contemplated.

1. A chromatographic composition comprising:
a solid phase substrate; and
an ionically-modified hydrophilic ligand coupled to the solid phase substrate, the ionically-modified hydrophilic ligand comprising;
a hydrophilic ligand portion covalently bonded to the solid phase substrate with the hydrophilic ligand portion including a polar group and a plurality of hydroxyl groups, and
an ionic group directly or indirectly coupled to the hydrophilic ligand portion.

2. The chromatographic composition of claim 1 wherein the ionically-modified hydrophilic ligand derived from Formula I:
(R¹O)₃Si—[C(R²)(R³)]ₙ−X−[C(R²)(R³)]_{n′}—[C(R⁴)(R⁵)]ₘ—Zₚ—Yₛ Formula I
wherein:
X is the polar group;
Z is a polar connecting group;
Y is the ionic group;
n is 1-6;
n′ is 0-2;
m is 2-8;
p is 0 or 1;
s is 1;
R¹, R², R³, is independently H or a straight or branched, substituted or unsubstituted, C1 to C18 alkyl group; and
R⁴ and R⁵ is independently H or OH and at least two m units include at least one hydroxyl group.

3. The chromatographic composition of claim 2 wherein the hydrophilic ligand portion is derived from Formula Ia:
(R¹O)₃Si—[C(R²)(R³)]ₙ—X—[C(R²)(R³)]_{n′}—[C(R⁴)(R⁵)]ₘ— Formula Ia
wherein:
X is the polar group;
n is 1-6;
n′ is 0-2;
R¹, R², R³, is independently H or a straight or branched, substituted or unsubstituted, C1 to C18 alkyl group; and
R⁴ and R⁵ is independently H or OH and at least two m units include at least one hydroxyl group.

4. The chromatographic composition of claim 2 wherein the polar group X is independently chosen from a carbonate, a carbamate, an amide, an amine, an ureido, an ether, a thioether, a sulfinyl, a sulfoxide, a sulfonyl, a thiourea, a thiocarbonate, or a thiocarbamate, including heterocyclic compounds including the polar functionality.

5. The chromatographic composition of claim 4 wherein the polar group X is selected from an amide, a carbamate, or a ureido group.

6. (canceled)

7. The chromatographic composition of claim 2 wherein:
n is 2-4;
m is 3-6;
p is 1; and
R¹, R², R³, is independently H or a straight or branched, substituted or unsubstituted, C1 to C6 alkyl group.

8. The chromatographic composition of claim 7 wherein the polar connecting group Z is a carbamate group.

9. The chromatographic composition of claim 1 wherein the ionically-modified hydrophilic ligand is derived from Formula II:

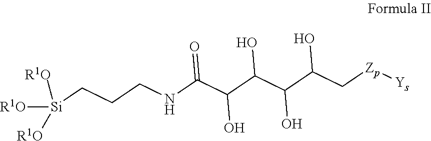

10. The chromatographic composition of claim 2 wherein ionic group Y is represented by Formula III as:
[C(R⁶)(R⁷)]ₖ—I Formula III
wherein:
k is 1-8;
R⁶ and R⁷ is independently H or a straight or branched, substituted or unsubstituted, C1 to C18 alkyl group, which may also contain halocarbon or alcohol substitutions, and
I is a charge-bearing functional group capable of either;
i. bearing a positive ionic charge in neutral or acidic aqueous or aqueous organic solvent conditions, or
ii. bearing a negative ionic charge in suitably neutral or basic aqueous or aqueous organic solvent conditions.

11. The chromatographic composition of claim 10 wherein I is a primary, secondary, tertiary or quaternary amine.

12. The chromatographic composition of claim 11 wherein the nitrogen atom of the amine is bonded to hydrogen, an alkyl, an alcohol substituted alkyl, an aromatic group, and combinations thereof.

13. The chromatograph composition of claim 12 wherein I is a tertiary amine.

14. The chromatographic composition of claim 10 wherein I is an immobilized carboxylic acid or sulfonic acid.

15. The chromatographic composition of claim 1 wherein the ionically-modified hydrophilic ligand is derived from Formula IV:

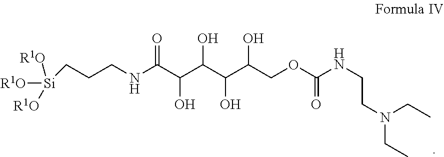

16. (canceled)

17. The chromatographic composition of claim 2 further comprising a hydrophilic ligand covalently bonded to the solid phase substrate wherein the hydrophilic ligand is derived from Formula V:
(R¹O)₃Si—[C(R²)(R³)]ₙ—X—[C(R²)(R³)]_{n′}—[C(R⁴)(R⁵)]ₘ—[C(R⁸)(R⁹)]_{q} Formula V
wherein:
X is the polar group;
n is 1-6;
n′ is 0-2;
m is 2-8;
q is 1;
R¹, R², R³, is independently H or a straight or branched, substituted or unsubstituted, C1 to C18 alkyl group;
R⁴ and R⁵ is independently H or OH and at least two m units include at least one hydroxyl group; and
R⁸ and R⁹ is independently H or OH provided that at least one of R⁸ and R⁹ is OH.

18. The chromatographic composition of claim 17 wherein the hydrophilic ligand of Formula V is derived from Formula Va: 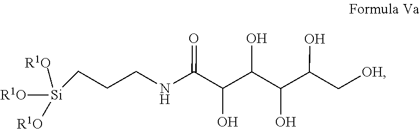
and;
wherein the ionically-modified hydrophilic ligand and the hydrophilic ligand are present in a molar ratio range of from 1:10 to 10:1.

19. (canceled)

20. The chromatographic composition of claim 1 wherein the solid phase substrate is a silica material or a hybrid inorganic/organic material.

21. (canceled)

22. The chromatographic composition of claim 1 for use in hydrophilic interaction liquid chromatography or mixed-mode hydrophilic interaction liquid chromatography.

23. A kit comprising the chromatographic composition of claim 1.

24. A separation device, comprising the chromatographic composition of claim 1 wherein the separation device is further defined as a chromatographic column, a thin layer plate, a filtration membrane, a microfluidic separation device, a sample cleanup device, a solid support, a solid phase extraction device, a microchip separation device, or a microtiter plate.

25. A method of producing a chromatographic composition including an ionically-modified hydrophilic ligand, said method comprising:
providing a solid phase substrate;
providing a hydrophilic ligand including a polar group and a plurality of hydroxyl groups with at least one hydroxyl group present at a terminus of the hydrophilic ligand;
reacting the solid phase substrate and the hydrophilic ligand to covalently couple the hydrophilic ligand to the solid phase substrate to form a hydrophilic-modified substrate;
providing an activation compound including a leaving group;
reacting the activation compound with the terminus hydroxyl group of the hydrophilic-modified substrate to form an activated hydrophilic-modified substrate;
providing an ionic modifier including a nucleophile and an ionic group; and
reacting the activated hydrophilic-modified substrate with the ionic modifier to release the leaving group of the activation compound and form the ionically-modified hydrophilic ligand.

26. The method of claim 25 wherein the hydrophilic ligand is represented by Formula V:
(R¹O)₃Si—[C(R²)(R³)]ₙ—X—[C(R²)(R³)]_{n′}—[C(R⁴)(R⁵)]ₘ—[C(R⁸)(R⁹)]_{q} Formula V
wherein:
X is the polar group;
n is 1-6;
n′ is 0-2;
m is 2-8;
q is 1;
R¹, R², R³, is independently H or a straight or branched, substituted or unsubstituted, C1 to C18 alkyl group;
R⁴ and R⁵ is independently H or OH and at least two m units include at least one hydroxyl group; and
R⁸ and R⁹ is independently H or OH provided that at least one of R⁸ and R⁹ is OH to represent the hydroxyl group present at the terminus of the hydrophilic ligand.

27.-29. (canceled)

30. The method of claim 29 wherein:
n is 2-4;
m is 3-6;
p is 1; and
R¹, R², R³, is independently H or a straight or branched, substituted or unsubstituted, C1 to C6 alkyl group.

31. (canceled)

32. The method of claim 30 wherein the ionic modifier is represented by Formula VI,
W—[C(R⁶)(R⁷)]ₖ—I Formula VI,
wherein,
W is a nucleophile;
k is 1-8;
R⁶ and R⁷ is independently H or a straight or branched, substituted or unsubstituted, C1 to C18 alkyl group, which may also contain halocarbon or alcohol substitutions;
I is a charge-bearing functional group capable of either i. bearing a positive ionic charge in neutral or acidic aqueous or aqueous organic solvent conditions, or ii. bearing a negative ionic charge in suitably neutral or basic aqueous or aqueous organic solvent conditions.

33. (canceled)

34. The method of claim 32 wherein the ionic modifier is N,N-(diethyl)-diaminoethane;
wherein the ionic group of the ionic modifier is a tertiary amine;
wherein the activation compound is mesyl chloride, tosyl chloride, phosphorus tribromide, thionyl chloride, or a combination thereof; and
wherein the polar group X is independently chosen from a carbonate, a carbamate, an amide, an amine, a urea, an ether, a thioether, a sulfinyl, a sulfoxide, a sulfonyl, a thiourea, a thiocarbonate, or a thiocarbamate, including heterocyclic compounds including the polar functionality.

35.-39. (canceled)

40. The method of claim 26 wherein the ionically-modified hydrophilic ligand is represented by Formula I:
(R¹O)₃Si—[C(R²)(R³)]ₙ—X—[C(R²)(R³)]_{n′}—[C(R⁴)(R⁵)]ₘ—Zₚ—Yₛ Formula I
wherein:
X is the polar group;
Z is a polar connecting group;
Y is the ionic group;
n is 1-6;
n′ is 0-2;
m is 2-8;
p is 0 or 1;
s is 1;
R¹, R², R³, is independently H or a straight or branched, substituted or unsubstituted, C1 to C18 alkyl group; and
R⁴ and R⁵ is independently H or OH and at least two m units include at least one hydroxyl group.

41. The method of claim 25 wherein the ionically modified hydrophilic ligand is represented by:

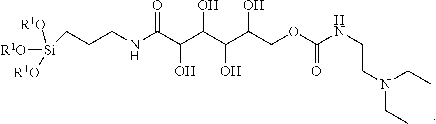

42.-51. (canceled)
